(19) United States
(12) Patent Application Publication
(10) Pub. No.: US 2016/0264059 A1
(43) Pub. Date: Sep. 15, 2016

(54) WINDING SHAFT UNIT FOR RECEIVING A ROLLER BLIND SHEET

(71) Applicants: Guenter RENZ, Ditzingen (DE); Cristian WINKLER, Baldham-Vaterstetten (DE)

(72) Inventors: Guenter RENZ, Ditzingen (DE); Cristian WINKLER, Baldham-Vaterstetten (DE)

(21) Appl. No.: 15/067,281

(22) Filed: Mar. 11, 2016

(30) Foreign Application Priority Data
Mar. 11, 2015 (DE) 10 2015 204 410.6

(51) Int. Cl. B60R 5/04; B65H 75/10; B65H 75/38

(52) U.S. Cl. CPC B60R 5/047; B65H 75/38; B65H 75/10

(57) ABSTRACT

A winding shaft unit for receiving a roller blind sheet in a wound-up condition, wherein the winding shaft unit has a winding tube extending in the direction of a rotation axis and the winding shaft unit has at least one bearing bush inserted into the winding tube, the bush being a terminal closure of the winding tube, wherein the bearing bush has, on a circumferential exterior surface, a contact zone for resting on an interior surface of the winding tube and has, on a circumferential interior surface, a bearing zone for cooperation with a bearing pin. The bearing bush is made partially of a first material and partially of a second material differing from the first material.

### CROSS-REFERENCE TO RELATED APPLICATIONS

This claims priority from German Patent Application No. 10 2015 204 410.6, filed on Mar. 11, 2015, the disclosure of which is hereby incorporated by reference in its entirety into this application.

### FIELD OF APPLICATION AND PRIOR ART

The invention relates to a winding shaft unit for receiving a roller blind sheet. The invention further relates also to a roller blind system comprising such a winding shaft unit and to an automotive vehicle including such a roller blind system.

Well-known from the prior art is a tubular winding shaft unit as a rotating part of a roller blind system. On the exterior side of a winding tube of the winding shaft unit, a roller blind sheet can be received in a wound-up condition. The winding shaft unit is commonly supported by bearing bushes inserted from an end face into the winding tube, which usually has an inner diameter from 5 mm to 20 mm, to be rotatable about bearing pins inserted from an end face into the bearing bushes of the roller blind system. Unwinding of the roller blind sheet from the winding tube is usually against the force of a winding-up spring which typically is disposed within the winding shaft unit.

Such roller blind systems are employed in particular also in the field of automotive vehicles, for loading space coverings, loading space partitions and window shading devices, for example.

Well-known are bearing bushes which usually are one-piece synthetic material components made of low-elasticity synthetic materials. Such bearing bushes commonly have a drawback in that they do not exhibit ideal sealing and absorption characteristics. As a result, vibrations are transferred unhindered via the bearing bush to the bearing pin which, in turn, generates a rattling noise by interaction with the bearing bush. The aim is to eliminate or alleviate such undesired noises. Also, the well-known bearing bushes made of low-elasticity synthetic materials are not always capable of providing sufficient sealing of the interior of the winding shaft unit against the environment. As a result, during a life cycle of the grease-filled winding shaft unit, grease and oil, separated from the grease due to ageing, may leak out to the environment and cause contaminations.

### OBJECT AND SOLUTION

An object of the invention is to provide a winding shaft unit having improved characteristics in terms of noise emission and/or sealing of an interior space of the winding shaft unit in relation to the environment.

The object is achieved by a winding shaft unit according to claim 1.

The winding shaft unit comprises a winding tube extending in the direction of a rotation axis of the winding shaft unit. A bearing bush is inserted into the winding tube of said winding shaft unit at least on one end thereof, said bush being a terminal closure of the winding tube.

In a contact zone, the exterior surface of the bearing bush rests on the interior side of the winding tube at least partially and is maintained connected to the winding tube in a non-positive or positive manner for conjoint rotation during operational stresses and strains.

The interior side of the bearing bush rests, in the installed condition, in a bearing zone at least partially on a bearing pin extending on the end face from the exterior into the bearing bush, and constitutes a slide bearing together with the bearing pin.

The bearing bush is composed partially of the first material and partially of the second material differing from the first material. The use of a bearing bush composed of two solidly interconnected different materials allows an association of simple installation of the bearing bush and advantageous performance in operation. Using different material combinations allows perfect adaptation of the bearing bush to the respective requirements in specific fields.

In an embodiment, the first material is softer (has superior plasticity) as compared to the second material, wherein the softer first material is deformable with less force applied. There is elastic deformability.

Rubber or an elastic synthetic material can preferably be used for the first material. In particular elastomers and/or silicon-based synthetic materials are suited for said application.

The softer, elastically deformable material is in particular suited for portions which are intended for a non-positive or force-fit coupling, in particular to the winding tube, and/or intended for a sealing effect and/or absorption effect.

A portion of the bearing bush made of the first material can form at least one or a plurality of axially spaced outwards facing contact sites made of the first material of the bearing bush within the contact zone. The contact site can have a circumferential peripheral design or a discontinuous design and constitute a sealing and/or absorption surface. A force-fit connection to the winding tube can be established via the contact site. The contact site can seal the, usually grease-filled, interior of the winding shaft unit in relation to the environment. By using the softer first material for producing the contact sites, an improved sealing and absorption is achieved.

A portion of the bearing bush made of the first material can form at least one or a plurality of axially spaced inwards projecting bearing surfaces made of the first material within the bearing zone. The bearing surface can have a circumferential peripheral design or a discontinuous design. Said portion made of the first material supports the bearing pin against the less soft second material of the bearing bush and prevents direct contact between them. By producing the bearing surface from the first material, an advantageous vibration absorbing effect is achieved.

A portion of the bearing bush made of the first material can form an axial absorption surface. The axial absorption surface is disposed between the side of a collar of the bearing bush facing away from the winding tube and a shoulder of the bearing pin abutting the collar of the bearing bush. The axial absorption surface can be designed to extend circumferentially or discontinuously around the end face of the collar of the bearing bush. The axial absorption surface prevents noise development between the collar of the bearing bush and the shoulder of the bearing pin. Likewise, an axial sealing surface between the side of the collar of the bearing bush facing towards the winding tube and the end face of the winding tube is possible.

A portion of the bearing bush made of the first material can form at least one or a plurality of axially spaced inwards facing sealing lips in the bearing zone. For reasons of sealing the grease-filled interior side of the winding tube, the sealing lip is preferably embodied in a circumferential peripheral design. The sealing lip is preferably a sealing surface inclined relative to the rotation axis and, in particular, has a cone section shape. An advantage with such sealing lips is, in particular, that they are one-piece parts of the bearing bush, since installation in a wrong arrangement is excluded if the bearing bush can be inserted into the winding tube but in one orientation and, thus, the orientation of the sealing lip is predetermined. The sealing lip can also have a bearing function, so that a separate bearing surface is not mandatory.

Applicable for use as the softer first material are materials exhibiting a Young's modulus of less than/equal to 200 MPa. Particularly preferred is a Young's modulus of less than/equal to 100 MPa, or even less than/equal to 50 MPa. Such material can, for example, be elastomers or thermoplastics. For example, the material could be soft PVC, fluorinated rubber, silicon rubber, or acrylonitrile-butadiene rubber. Preferably, the softer first material exhibits a Young's modulus of about 10 MPa. Said criterion is met by silicon rubber, for example.

The second material can be a synthetic material or a metal, preferably a more rigid synthetic material or a light metal alloy. The second material is less soft (has less plasticity) as compared to the first material. Owing to superior rigidity, as compared to the first material, the second material can form support structures for the first material. The less soft second material is appropriate, in particular, for portions that are to impart stability to the bearing bush. In addition, said material can be employed preferably on external surfaces, for example on the side of the collar facing the front end of the winding tube that is to abut in defined relative position to the winding tube.

A portion of the bearing bush made of the second material can constitute a circumferential sleeve structure which is concentric to the winding tube and disposed in the interior thereof. A defined geometric shape is produced from the less soft second material and constitutes said support structure of the bearing bush.

A portion of the bearing bush made of the second material can form said above mentioned collar in a circumferential or discontinuous design, with the outer diameter of the collar exceeding the inner diameter of the winding tube. Said collar can be an abutment surface of the bearing bush on the winding tube and in the installed condition is located exterior of the winding tube. By producing said collar from the less soft second material, an exact positioning of the bearing bush relative to the winding tube can be achieved.

The bearing bush can have an anti-rotation portion which prevents twisting of the bearing bush in relation to the winding tube by means of a complementary anti-rotation portion or an anti-rotation recess of the winding tube, preferably in a positive-locking or form-fit manner. Said anti-rotation portion as well is preferably made of the less soft second material.

The circumferential sleeve structure and/or the collar made of the second material can include at least one perforation which has a circumferentially enclosed or incision-type design. Preferably, the sleeve structure has a plurality of perforations distributed over the circumference and/or the end faces. Through said perforations, portions made of the first material can be interconnected on the interior side and the exterior side of the sleeve structure. If the second material has an increased specific density as compared to the first material, a result thereof can be an advantageous weight. For example, with the bearing bush produced by multi-component injection molding, but without a transition zone in sufficient material-bonding engagement, preventing mutual relative movement of the two materials by form-fitting securing cannot be obtained, as a result.

Likewise, form-fitting securing can be achieved by non-circumferential recesses in the sleeve structure and/or on the collar made of the second material, with the portions made of the first material projecting therein.

Applicable for use as the less soft second material can be materials exhibiting a Young's modulus greater than 200 MPa, in particular greater than 1,000 MPa, particularly preferred greater than 2,500 MPa. Said prerequisite is met by thermoplastics, like polyimide, polystyrene, polyoxymethylene and hard PVC, for example.

The bearing bush can have a contiguous portion composed of the less soft second material, which portion is connected to at least two not directly contiguous portions made of the softer first material. Accordingly, with such a design, there is a plurality of portions made of the first material provided, which portions are connected only indirectly by a portion made of the second material, in particular by the sleeve structure. Said portions thereby form a variety of said functional zones made of the first material, like the contact zone, the bearing zone, the sealing lip, or the axial absorption surface. An advantage of said design may be that by providing the softer first material in portions, an optimized weight and raw material input can be achieved.

As an alternative, the surface of the bearing bush can be composed of the softer first material, at least for the predominant part. Thus, with such a design, all components made of the softer first material are interconnected. Thus, production is simplified, since not more than one injection point is needed for the first material. The first material can completely surround the second material and in particular the sleeve structure manufactured therefrom, so that the second material forms a core that is protected towards the outside. However, it may be advantageous, that the second material remains partially exposed for producing functional portions. For instance, preferably the side of the collar of the bearing bush facing the winding tube is composed of the less soft second material. Since thereby said side of the collar is less soft, it can serve as an abutment and predetermine a defined position of the bearing bush in relation to the winding tube.

The winding shaft unit can include two bearing bushes which are inserted into the winding tube on opposite sides and form a terminal closure of the winding tube, wherein each bearing bush is composed partially of the first material and partially of the second material.

A material-free radial perforation for receiving a retaining splint can be provided in the first and the second materials and in the bearing pin and the winding tube

The bearing bush can also include more than two materials. Thus, additional metallic inserts can have a positive effect on the performance of a sealing lip facing towards the bearing pin, for example.

The sealing surface made of the first material can be provided on a support portion which has an asymmetric shape design as compared to an axial cross-sectional plane of the winding tube. For example, this is obtained by a conical shape design of the support portion. Particularly with such an asymmetric design of the sealing, integral attachment as part of a bearing bush according to the invention is advantageous, since assembly errors are prevented.

The invention relates, in addition to the winding shaft unit per se, also to a roller blind system according to claim 9, which system is provided with such a winding shaft unit.

The roller blind system can have a bearing device including at least one bearing pin. Preferably the roller blind system has two bearing pins which are inserted into the end face ends of the winding tube of the winding shaft unit and are connected to a cartridge housing.

The roller blind system has a winding shaft unit according to any of the preceding claims, which is rotatable in relation to the bearing device, wherein for that purpose the bearing zone of the bearing bush and the bearing pin are configured to cooperate in the manner of a slide bearing.

The invention furthermore also relates to an automotive vehicle according to claim 10, which is provided with such a roller blind system. In that context, the roller blind system can be a roller blind system for loading space partitioning including a roller blind sheet to be drawn out in the vertical direction, preferably in the form of a net. Furthermore, the roller blind system can be designed for loading space covering and for that purpose include a roller blind sheet to be drawn out essentially in the horizontal direction. Furthermore, such a roller blind system in a vehicle can be designed for the aim of window shading.

### BRIEF DESCRIPTION OF THE DRAWINGS

FIG. 1 shows the interior of an automotive vehicle with a roller blind system for the purpose of loading space covering, comprising a cartridge housing, a rotatable winding shaft unit disposed therein and not illustrated in FIG. 1, and a roller blind sheet to be wound off and wound on to said unit.

FIGS. 2 to 6 show a first exemplary embodiment of a roller blind system according to the invention including a winding shaft unit with bearing bush according to the invention. With said exemplary embodiment, a support structure composed of a less soft second material is sheathed by a softer first material over a large area.

FIG. 2 shows the first exemplary embodiment in a broken sectional view with cartridge housing and an internally-disposed winding shaft unit.

FIGS. 3 and 4 show the bearing bush according to the first exemplary embodiment in a perspective illustration and in a side view, respectively. The support structure composed of a less soft second material is sheathed by the softer first material over a large area.

FIGS. 5 and 6 show the support structure of the bearing bush composed of the less soft second material according to FIGS. 3 and 4 in a perspective view and in a side view, respectively.

FIGS. 7 and 8 show a second exemplary embodiment of the invention and the respective bearing bush. Said exemplary embodiment shows a support structure composed of the less soft second material, whereon the softer first material is applied only partially.

FIG. 7 shows the bearing bush according to the second exemplary embodiment in a longitudinal section.

FIG. 8 shows the bearing bush according to the invention according to the second exemplary embodiment in a perspective view.

### DETAILED DESCRIPTION OF THE EXEMPLARY EMBODIMENTS

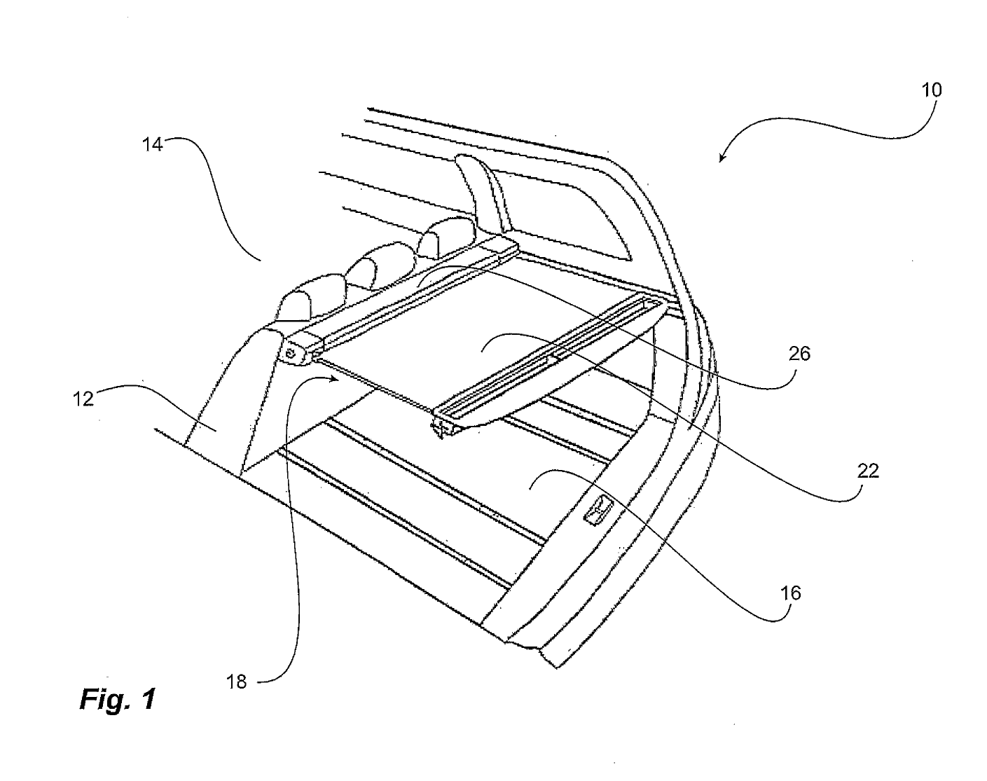

The invention will be explained with reference to two exemplary embodiments, wherein FIG. 1 refers to both exemplary embodiments.

FIG. 1 shows a schematic presentation of an automotive vehicle 10 which is provided with a roller blind system 18 for a loading space covering. The roller blind system 18 is constituted by a roller blind sheet 22 and a cartridge housing 26, which is mounted within a vehicle interior on the back side of a rear seat bench 12 in the transverse direction of the vehicle. The roller blind sheet 22 divides the vehicle interior in a luggage compartment 16 and a passenger compartment 14. In the wound-up position of the roller blind sheet 22, only a withdrawing rod projects from the cartridge housing 26, and the luggage compartment 16 is open towards the passenger compartment 14. The roller blind sheet 22 serves for the purpose of safeguarding objects loaded and transported in the luggage compartment 16, in case of a vehicle crash, from dashing into the passenger compartment 14 and preventing ejection of the loaded objects from the vehicle 10. For this purpose, the roller blind sheet 22 is wound off the cartridge housing 26 proximately horizontally and is fixed in the functional position thereof using retaining means in the vicinity of the tailgate.

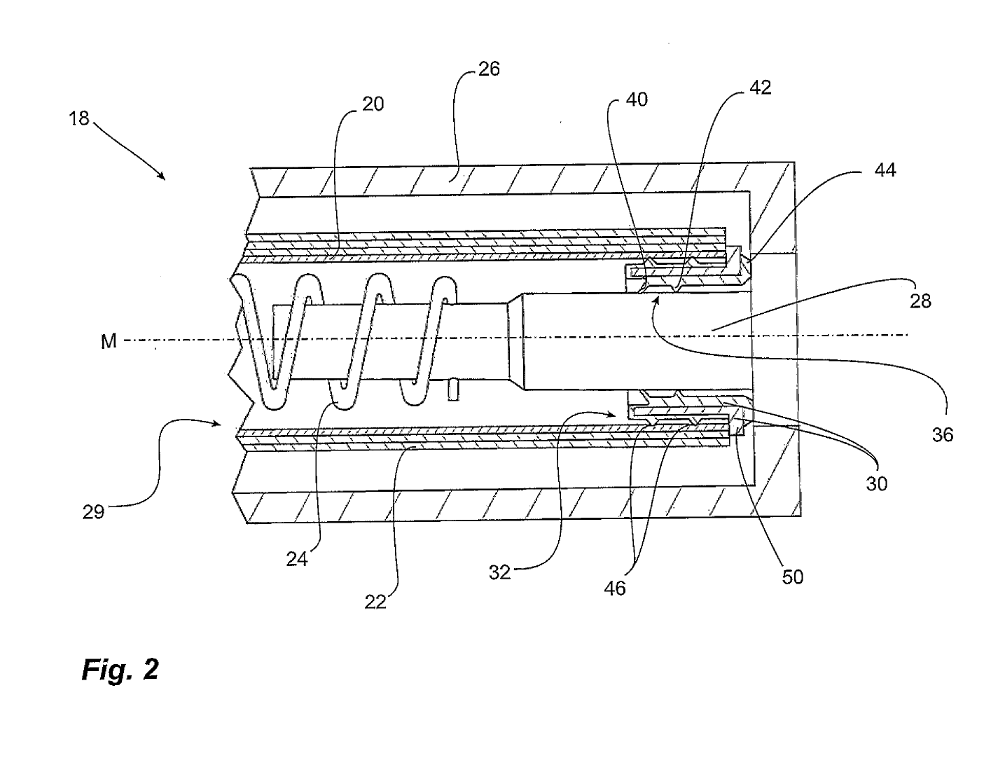

The FIGS. 2 to 6 show a bearing bush of a first exemplary embodiment of a winding shaft unit according to the invention.

FIG. 2 shows in a broken sectional view of a cartridge housing 26 with internally-disposed rotating winding shaft unit 29, comprising a winding tube 20, which is rotatable about a rotation axis M, and a bearing bush 30 inserted therein on the terminal end. An identical bearing bush is inserted on the opposite end.

The cartridge housing 26 surrounds an interior space and two bearing pins 28 extend into said space from opposite end faces. Said pins form a respective slide bearing together with the bearing bushes 30 inserted on both sides into the winding tube 20 for pivot-mounting of the winding shaft unit 29.

The roller blind sheet 22 is received on the winding tube 20 in a wound-up condition. A winding-up spring 24 is fixed on the stationary bearing pin 28 on a location near the bearing. On the axially opposite side, the winding-up spring 24 is connected to the pivot-mounted winding tube 20. During winding-off the roller blind sheet 22 from the winding tube 20, the winding shaft unit 29 rotates about the bearing pins 28. Thereby, the winding-up spring 24 is tensioned. The roller blind sheet 22 is fixed in the wound-off functional position using retaining elements in the vicinity of the tailgate. Upon releasing said fixation, the winding-up spring 24 relaxes and causes winding-up of the roller blind sheet 22.

What is illustrated is an embodiment of the bearing bush 30 having two contact sites 46 in a contact zone 32 of the bearing bush 30 and having a sealing lip 40 and a bearing surface 42 in a bearing zone 36 of the bearing bush 30. The contact sites 46 mount and seal the exterior circumference of the bearing bush 30 in relation to the interior circumference of the winding tube 20. The two axially spaced contact sites 46 support the bearing pin 28 in the contact zone 32 and, thus, prevent tilting movement of the bearing bush 30 in the winding tube 20. A sealing lip 40 lies circumferentially against the bearing pin 28 and prevents leaking of lubricants. The bearing pin 28 rests on the sealing lip 40 and additionally on a bearing surface 42. Thereby, tilting movement of the bearing pin 28 in the bearing bush 30 is prevented. An axial absorption surface 44 cushions the end face of the bearing bush 30 facing away from the winding tube 20 against abutment of the bearing pin 28 on the winding tube side.

he bearing bush 30 includes two materials. A softer first, elastically deformable material, from which material the sealing lip 40, the axial absorption surface 44, the contact sites 46 and the bearing surfaces 42 are molded. Presently, the softer first material is a silicon rubber. Additionally, the bearing bush includes a less soft second material, from which material a support structure 50 having a geometrically defined shape is produced. Presently, the less soft material is selected from polyamides (PA).

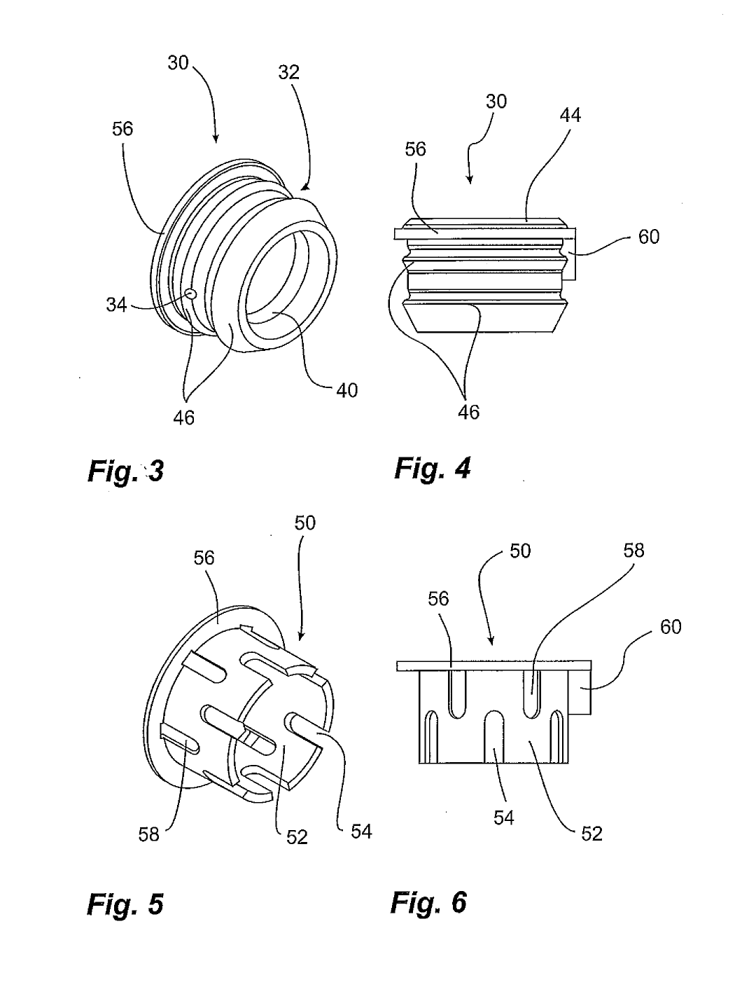

The FIGS. 3 and 4 show the first embodiment of the bearing bush 30 according to the invention in a separate illustration. The softer first material extends over a large part of the surface of the support structure 50 which is manufactured from the less soft second material. Exempt thereof is a portion of the collar 56 facing the winding tube 20. On the exterior circumference of the bearing bush 30 are disposed the two circumferential peripheral contact sites 46 made of the softer first material and axially spaced. The bearing bush 30 has a radially penetrating perforation 34 for receiving a retaining splint. On the interior circumference the bearing bush 30 has a circumferential peripheral and projecting sealing lip 40 made of the softer material. The two projecting, circumferential peripheral contact sites 46 on the exterior circumference of the bearing bush 30 rest on the interior circumference of the winding tube 20. At the contact sites 46 and together with the interior circumference of the winding tube 20, clamping of the bearing bush 30 within the winding tube 20 is obtained. Additionally, the contact sites 46 seal the interior of the winding shaft unit 29 in relation to the environment and absorb vibrations. The axial absorption surface 44 on the side facing the bearing pin 28 absorbs vibrations between the rotating winding tube 20 and the stationary bearing pin 28. The collar 56 and an anti-rotation portion 60 are made of the second less soft material. They constitute said support structure 50. The anti-rotation portion 60 is an integral part of the support structure 50 and extends axially in the direction of the winding tube 20 along the bearing bush 30. The portion of the collar 56 not covered by the softer first material is intended to obtain a defined relative position with the winding tube 20. The anti-rotation portion 60 made of the less soft second material is intended to obtain a form-fitting securing against relative movements of the winding tube 20 and the bearing bush 30 using an anti-rotation portion of the winding tube 20 complementary to the anti-rotation portion 60.

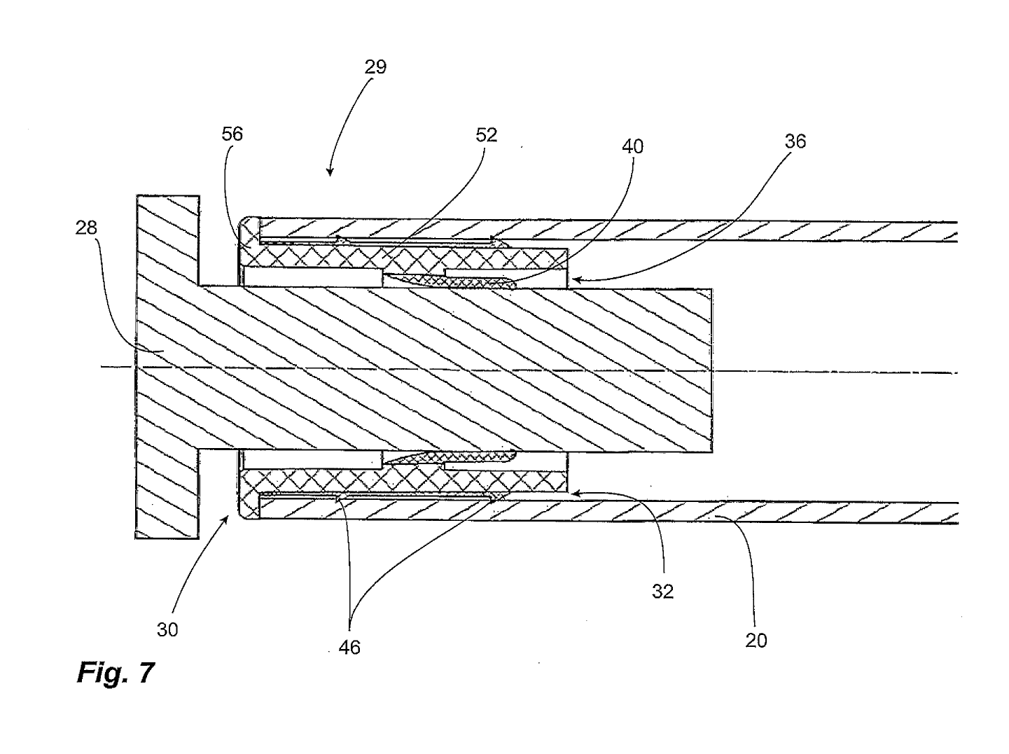

FIG. 5 and FIG. 6 show the support structure 50 of the bearing bush 30 with portions made of the softer first material concealed. The support structure 50 is composed of a sleeve structure 52 which is inserted into the winding tube 20 in the axial direction of the winding shaft unit 29, and the collar 56 which has a cross section greater than the inner diameter of the winding tube 20. The sleeve structure 52 has circumferentially enclosed perforations 58 and incision-type perforations 54 distributed over the circumference of the sleeve structure 52. The circumferentially enclosed perforations 58 penetrate also the part of the collar 56 adjoining the sleeve structure 52. In order to ensure an improved connection of the two materials of the bearing bush 30, the softer first material penetrates the perforations 54, 58 of the support structure 50 made of the less soft second material during the injection procedure and encloses the portions of the support structure 50 as predefined by the shape of the injection mold. Owing to said penetrated, form-fitting connection of the two materials, an increased anti-rotation effect of the two components in relation to each other is achieved. The circumference of the sleeve structure 52 has the incision-type perforations 54 and the circumferentially enclosed perforations 58. Said perforations 58 extend also over a part of the collar 56 adjoining the sleeve structure 52. The anti-rotation portion 60 made of the less soft second material is integrally molded on the side of the collar 56 facing the winding tube 20 in a transition zone to the sleeve structure 52. The anti-rotation portion 60 ensures together with a complementary anti-rotation recess in the winding tube 20, not illustrated, installation at an exact location and anti-rotation securing of the bearing bush 30 in relation to the winding tube 20. The perforations 54, 58 are for form-fitting connection of the two materials.

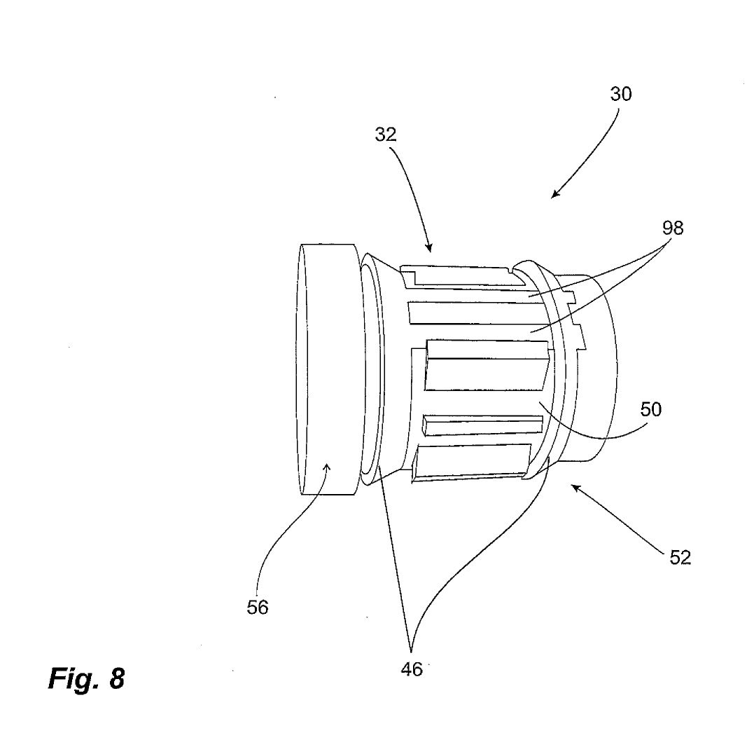

The FIGS. 7 and 8 show the bearing bush in a second embodiment.

FIG. 7 shows a perspective illustration of the exemplary embodiment according to the invention in a variant of the bearing bush 30 without extensive large area injection molding of the softer first material. The winding tube 20 is illustrated with the bearing bush 30 and the bearing pin 28. The bearing bush 30 is inserted into the winding tube 20 on the end face side. The bearing bush 30 is composed of two components, the softer first material and the less soft second material. Made of the softer first material are the sealing lip 40 in the bearing zone 36 and the contact sites 46 in the contact zone 32. Made of the less soft second material are the collar 56 and the sleeve structure 52. The circumferential peripheral sealing lip 40 extending on the interior circumference of the bearing bush 30 rests on the exterior circumference of the bearing pin 28. The circumferential peripheral contact sites 46 on the exterior circumference of the bearing bush 30 rest on the interior circumference of the winding tube 20. The sealing lip 40 seals the interior of the winding shaft unit 29 in relation to the environment and similarly offers a bearing function for the bearing pin 28. The contact sites 46 provide a force-fit connection to the winding tube 20, seal the interior of the winding shaft unit 29 in relation to the environment and absorb vibrations. The perforated sleeve structure 52 and the collar 56 are made of the less soft second material. Owing to its less resilient, geometrically defined shape, the collar 56 predetermines the position of the bearing bush 30 in the winding tube 20 and the position of the bearing bush 30 in relation to the bearing pin 28. FIG. 8 shows a perspective view of the bearing bush 30 shown in FIG. 7 in a sectional view. The bearing bush 30 includes two materials. The softer first material penetrates circumferentially enclosed perforations 58 of the sleeve structure made of the less soft second material. The softer first material forms functional surfaces on the interior and on the exterior circumferences of the sleeve structure 52 of the bearing bush 30. On the exterior circumference are two axially spaced and projecting circumferential peripheral contact sites 46 as sealing and absorption surfaces. Said contact sites 46 are interconnected by two webs 98 extending axially along the contact zone 32 and made of the softer first material. The contact sites 46 on the exterior circumference seal and cushion the bearing bush 30 in relation to the winding tube 20 and provide a force-fit connection between the winding tube 20 and the bearing bush 30. The two axially extending webs 98 made of the softer first material prevent relative movement of the two contact sites 46 of the exterior circumference of the bearing bush 30 and relative movement in relation to the bearing bush 30. The major part of the surface of the bearing bush 30 is formed of the less soft second material. The less soft material constitutes the collar 56 which acts as abutment on the winding tube side on the end face side of the winding tube 20, and the location of the bearing bush 30 in relation to the winding tube 20 is predetermined by said collar. The collar 56 is an abutment for the bearing pin 28 on the side facing away from the winding tube and predetermines the location of the bearing bush 30 in relation to the bearing pin 28. The less soft second material also serves as support structure 50 for the softer first material and imparts shape and rigidity to the bearing bush 30.

The bearing bush 30 can be produced in a simple and cost-efficient manner using multi-component injection molding. Employment of the two different materials allows optimum adaptation of portions of the bearing bush 30 to different requirements. The softer first material is applied, as a function of requirements for the bearing bush 30, to the support structure 50 made of the less soft second material. Said application may be either extensively on a large area or partially in portions. Elastic portions made of the softer first material can meet functions of sealing, absorption and bearing and provide a force-fit connection to the winding tube 20 or the bearing pin 28. Rigid portions made of the less soft second material impart shape and stability to the bearing bush 30. The rigid portions can contribute to positioning and anti-rotation securing of the bearing bush 30, since positioning facilities, like the collar 56 and the anti-rotation portion 60, can be formed thereof.

1. Winding shaft unit for receiving a roller blind sheet in a wound-up condition, having the following features:
a. the winding shaft unit has a winding tube extending in the direction of a rotation axis, and
b. the winding shaft unit has at least one bearing bush, inserted into the winding tube, so that the bush is a terminal closure of the winding tube, and
c. the bearing bush has, on a circumferential exterior surface, a contact zone for resting on an interior surface of the winding tube, and
d. the bearing bush has, on a circumferential interior surface, a bearing zone for cooperation with a bearing pin, and
characterized by the following feature:
e. the bearing bush is composed partially of a first material and partially of a second material differing from the first material.

2. Winding shaft unit according to claim 1, having the following features:
a. the first material is softer as compared to the second material, and
b. the first material is rubber or an elastic synthetic material, in particular an elastomer and/or a silicon-based synthetic material.

3. Winding shaft unit according to claim 2, having at least one of the following features:
a. an outwards oriented contact site is formed from the first material in the contact zone, or
b. an inwards projecting bearing surface is formed from the first material in the bearing zone, or
c. an axial absorption surface is formed from the first material and is a terminal closure of the winding tube, or
d. an inwards oriented circumferential sealing lip is formed from the first material in the bearing zone.

4. Winding shaft unit according to claim 1, having the following feature:
a. the second material is a synthetic material or metal,

5. Winding shaft unit according to claim 1, having at least one of the following features:
a. a circumferential sleeve structure is formed from the second material, concentric to the winding tube and disposed in the interior thereof, or
b. a circumferential collar is formed from the second material, with the outer diameter of the collar exceeding the inner diameter of the winding tube, and the collar is disposed outside of the winding tube, or
c. an anti-rotation portion is formed from the second material, facing outwards and disposed in a recess of the winding tube, so that the bearing bush is anti-rotation secured on the winding tube in a form-fit manner.

6. Winding shaft unit according to claim 6, having the following feature:
a. the circumferential sleeve structure made of the second material has at least one perforation and through said perforations portions made of the first material can be interconnected on the interior side and the exterior side of the sleeve structure.

7. Winding shaft unit according to claim 1, having any of the following features:
a. the bearing bush has a contiguous portion composed of the second material, which portion is connected to at least two not directly contiguous portions made of the first material, or
b. the surface of the bearing bush is at least for the predominant part composed of the first material, wherein preferably at least part of the surface of the bearing pin is composed of the second material.

8. Winding shaft unit according to claim 1, having at least one of the following features:
a. the winding shaft unit has two bearing bushes, inserted into the winding tube, so that there is a terminal closure of the winding tube on opposite ends, wherein both the bearing bushes respectively are partially made of the first material and partially made of the second material, or
b. the sleeve structure and/or the adjacent collar include a plurality of perforations distributed over the circumference and/or the end face, or
c. in the first material and/or in the second material, on the one hand side, and in the winding tube, on the other hand side, a material-free axially extending perforation for receiving a retaining splint is provided, or
d. the winding tube has an inner diameter of minimum 5 mm and maximum 30 mm, or
e. the bearing bush is produced by multi-component injection molding, or
f. the bearing bush includes more than two materials, or
g. the sleeve structure made of the second material has recesses for form-fitting connection of the at least two materials, or
h. the sealing lip in the bearing zone additionally achieves a bearing function, or
i. the first material forms a sealing surface on an end face of the winding tube and the side of the collar of the bearing bush facing towards the winding tube, or
j. a sealing surface of the sealing lip made of the first material is provided on a support portion which has an asymmetric shape design as compared to an axial cross-sectional plane of the winding tube, or
k. the softer first material exhibits a Young's modulus of less than/equal to 200 MPa, preferably less than/equal to 100 MPa, particularly preferred less than/equal to 50 MPa, or
l. the less soft second material exhibits a Young's modulus of at least 200 MPa, preferably at least 1000 MPa, particularly preferred at least 2500 MPa.

9. Roller blind system having the following features:
a. the roller blind system includes a bearing device with at least one bearing pin, and
b. the roller blind system includes a winding shaft unit according to claim 1, which unit is rotatable in relation to the bearing device, wherein for that purpose the bearing zone of the bearing bush and the bearing pin are configured for cooperation in the manner of a slide bearing.

10. Automotive vehicle having the following feature:
a. the automotive vehicle includes a roller blind system according to claim 9.
